(19) United States
(12) Patent Application Publication
(10) Pub. No.: US 2025/0018988 A1
(43) Pub. Date: Jan. 16, 2025

(54) UTILITY HANDCART

(71) Applicant: Polymule, Inc., Lehi, UT (US)

(72) Inventors: Dennis Charles Draleau, II, Lehi, UT (US); Robert Byron Male, Bountiful, UT (US)

(21) Appl. No.: 18/743,290

(22) Filed: Jun. 14, 2024

Related U.S. Application Data
(60) Provisional application No. 63/508,829, filed on Jun. 16, 2023.

(51) Int. Cl. B62B 1/12; B62B 5/04

(52) U.S. Cl. CPC B62B 1/12; B62B 5/0404; B62B 5/048

(57) ABSTRACT

A utility handcart can include foldable struts to reduce an overall volumetric footprint of the handcart. The struts can be selectively rotated with a pin to fix the struts in either a stowed position or a downward position for supporting wheels during use. The utility handcart can also include an uphill assist mechanism securing the wheels to the struts or engaged with the wheel axles to prevent the wheels from rotating in one direction, for example backward, when parked or pulled up a hill. The uphill assist mechanism can be selectively engaged to either allow for rotation of the wheels in both directions or prevent the backward rotation of the wheels as desired by the user.

### CROSS-REFERENCE TO RELATED APPLICATION

This application claims priority to U.S. Provisional Patent Application No. 63/508,829, filed 16 Jun. 2023, entitled “Utility Handcart”, the disclosure of which is incorporated herein by reference in its entirety.

### FIELD

The present disclosure relates generally to carts. More particularly, the present disclosure relates to utility handcarts.

### BACKGROUND

Utility carts can be used for a wide variety of work and recreational activities, including outdoor activities on rough terrain and trails. Typical utility carts, including wagons, wheelbarrows, and handcarts, are hard to navigate over rough terrain and lack the broad functionalities needed by users, from outdoor recreation, camping, and everyday hauling to heavier duty activities including hauling wood, traversing mountain trails, search and rescue activities, and humanitarian aid operations in remote areas.

### BRIEF DESCRIPTION OF THE DRAWINGS

The disclosure will be understood by the following description in conjunction with the accompanying drawings, wherein like reference numerals designate like structural elements, and in which:

FIG. 1 illustrates a perspective view of an example of a handcart, according to the present disclosure;

FIG. 2 illustrates a front view thereof;

FIG. 3 illustrates a perspective view of an example of an uphill assist mechanism for a handcart, according to the present disclosure;

FIG. 4 illustrates a top view thereof;

FIG. 5 illustrates another top view thereof with the pin partially disengaged from the strut, according to the present disclosure;

FIG. 6 illustrates another top view thereof with the pin disengaged from the strut, according to the present disclosure;

FIG. 7 illustrates a perspective view thereof;

FIG. 8 illustrates a perspective view thereof with the mechanism rotated when disengaged from the strut, according to the present disclosure;

FIG. 9 illustrates an example of a strut of a handcart, according to the present disclosure;

FIG. 10 illustrates a perspective view thereof;

FIG. 11 illustrates the strut partially folded in a stowed position, according to the present disclosure;

FIG. 12 illustrates the strut in a stowed position, according to the present disclosure;

FIG. 13 illustrates a perspective view thereof; and

FIG. 14 illustrates a perspective view thereof.

### DETAILED DESCRIPTION

Detailed reference is provided below to representative examples illustrated in the associated drawings. The descriptions that follow are not intended to limit the examples to one preferred embodiment. Rather, they are intended to cover alternatives, variations, and equivalents within the spirit and scope of the embodiments described below and defined by the associated claims.

The present disclosure relates generally to carts. More particularly, the present disclosure relates to utility handcarts. The utility handcarts described herein can be used in a variety of settings and for a variety of functions, including everyday recreational hauling and heavy-duty outdoor hauling over rough terrain. The handcarts can include one or more uphill assist mechanisms engaging wheel axles. The uphill assist mechanisms can prevent the wheels from rotating in one direction, for example backward, when the user parks or moves the handcart on an incline. The uphill assist mechanisms described herein can be selectively engaged by the user to either limit the backward rotation of the wheels or allow rotation of the wheels in both directions as desired by the user.

In one example, the handcarts described herein can include adjustable wheel struts. The wheel struts can be rotated to extend downward when secured to the wheels or upward against a lower surface of the handcart container in a stowed position. The struts in the stowed position can minimize the overall volumetric footprint of the handcart for easy stowing and transport.

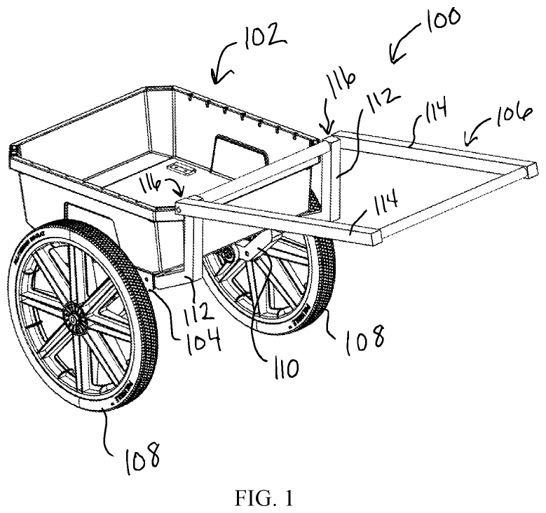

These and other embodiments are discussed below with reference to FIGS. 1-14. However, those skilled in the art will readily appreciate that the detailed description given herein with respect to these figures is for explanatory purposes only and should not be construed as limiting. Furthermore, as used herein, a system, a method, an article, a component, a feature, or a sub-feature including at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1 illustrates a front, top, perspective view of an example of a handcart 100. As shown in FIG. 1, the handcart 100 can include a container 102 having a base and sidewalls extending from the base to from a container volume. The container 102 can be molded as a single piece or assembled from multiple pieces. In at least one example, the handcart 100 can include a lower frame 104 onto which the container 102 is secured. The lower frame 104 can include one or more elongate members forming a platform, frame, or chassis onto which the container 102 and other handcart components, including the wheels 108, struts 110, and handle assembly 106 can be mounted.

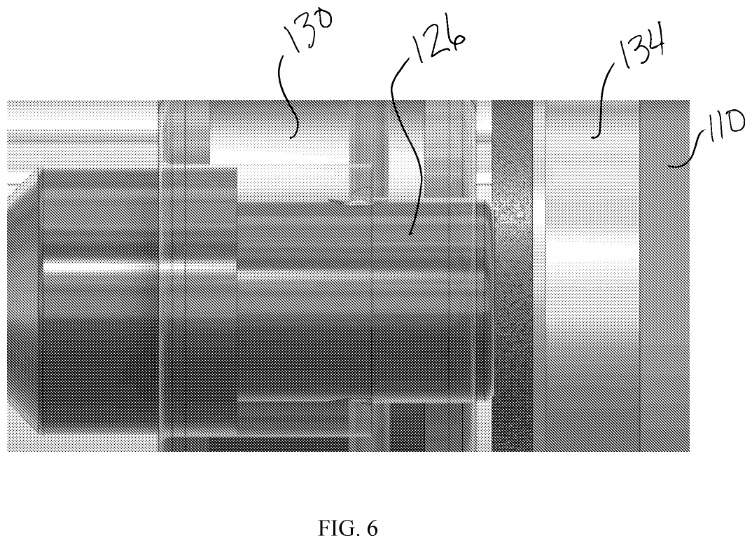

In at least one example, the handcart 100 can include a handle assembly 106 extending forward relative to the handcart 100. In at least one example, the handle assembly 106 includes a set of arms 114 pivotally secured to arm mounts 112. The arms 114 can pivotally secure to the arm mounts 112 at a pivot point or joint 116. The arm mounts 112 can extend forward from the lower frame 104 and upward in front of the container 102. The first end of the arm mounts 112 can be secured to the lower frame 104 as shown in FIG. 6 and the pivot joint 116 can be disposed at a second end of the arm mount 112 opposite the first end.

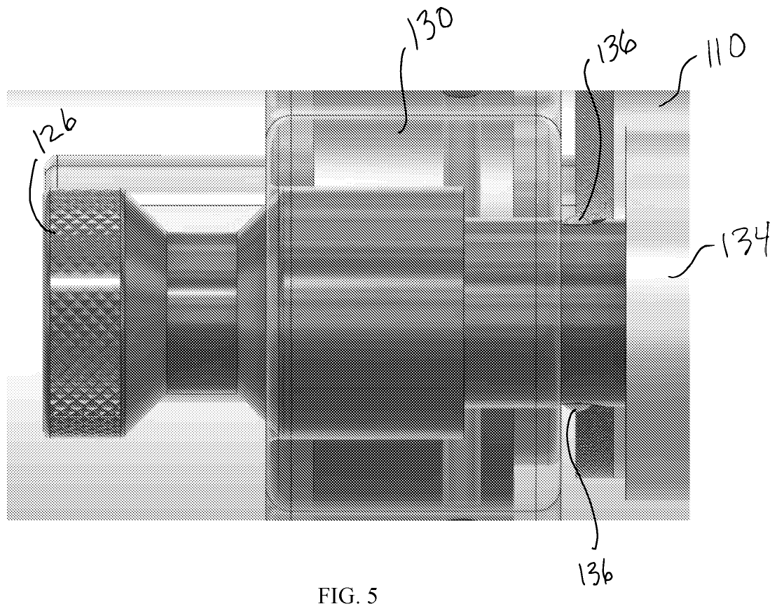

In at least one example, the pivot joint 116 can include a selectively rotatable mechanism for fixing the arms 114 of the handle assembly 106 at various angles relative to the arm mounts 112. In the illustrated example of FIGS. 5 and 6, the arms 114 are positioned and fixed at an angle configured for a user to pull or push the handcart 100. Depending on the height, size, and preference of the user, the arms 114 can be rotated to angles relative to the arm mounts 112 other than that shown in FIGS. 5 and 6. In at least one example, the multi-position pivot mechanism enabling the fixed position and selective change in angle of the arms 114 is disposed inside the arms 114 and the distal/second end of the arm mounts 112. The mechanism can include a trigger or button engageable by the user to instigate a change in position of the arms 114 during adjustments. When the trigger or button is released, the arms 114 can lock in place and be fixed relative to the arm mounts 112.

Any of the features, components, and/or parts, including the arrangements and configurations thereof shown in FIG. 1 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 1.

As noted above with reference to FIG. 1, the handcart 100 can include a selectively adjustable handle assembly 106 for changing the position or angle of the handle arms 114. In one configuration, the user can rotate the handle arms 114 and fix them downward about the pivot 116 such that the front or distal end of the handle arms 114 are configured to contact the ground. In this way, the handle arms 114 can act as a kickstand to rest the handcart 100 in position when the user is not pushing or pulling the handcart 100 along during use. Also, as noted above, the handcart 100 is configured to be used in outdoor setting and in rough terrain, including upward and downward sloped surfaces and trails. When the user stops and uses the handle arms 114 as a kickstand, or when the user pushes or pulls the handcart 100 uphill, it can be advantageous to prevent the handcart 100 from rolling down an incline when the user is not contacting the handcart 100 or when resting during movement.

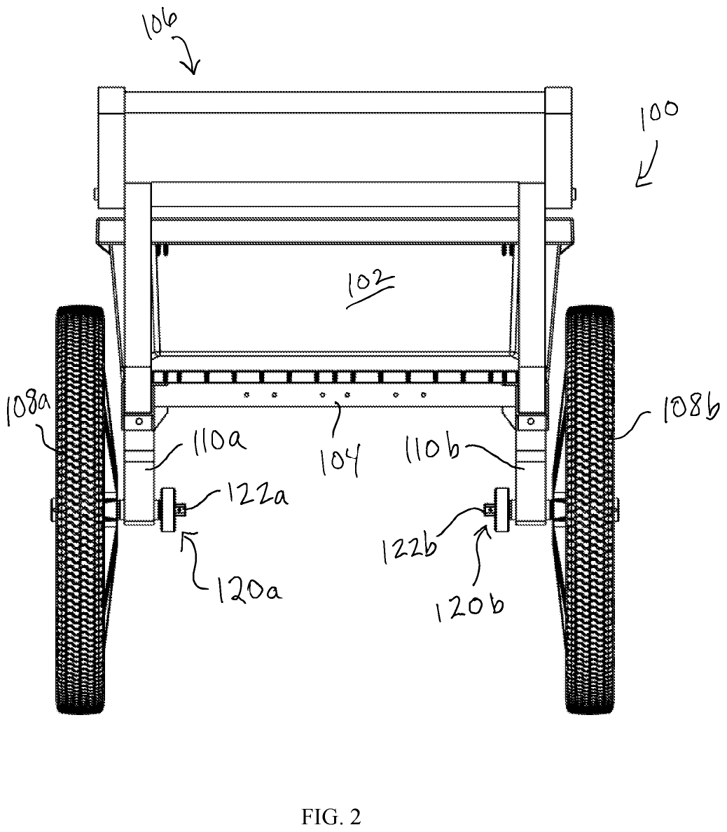

Along these lines, examples of the handcart 100 disclosed herein includes an uphill assist feature or mechanism. FIG. 2 illustrates a front view of the handcart 100 including uphill assist mechanisms 120a and 120b. The handcart 100 includes the container disposed above the lower frame 104 and the handle assembly 106 secured to the lower frame 104. The handcart 100 also includes first and second wheels 108a, 108b rotatably secured to first and second respective struts 110a, 110b extending downward from the lower frame 104. Each wheel 108a-b can be rotatably secured to a respective strut 110a-b via respective axles 122a and 122b, as shown in FIG. 2.

In at least one example, the uphill assist mechanisms 120a-b can enable the wheels 108a-b to rotate in a first direction, for example a forward direction while the user is pulling the handcart 100, but prevent the wheels 108a-b from rotating in a second direction opposite the first direction. In at least one example, the uphill assist mechanisms 120a-b can be selectively engaged or activated such that the user can decide to operate the handcart 100 with or without the prevention of the wheels in one direction. For example, the user can engage or activate the uphill assist mechanisms 120a-b when desired, for example when hauling the handcart 100 long distances uphill. In contrast, when the user desires to push and pull the handcart 100 in multiple directions or on flat or relatively flat ground, the user can disengage the uphill assist mechanisms 120a-b so as not to prevent the wheels 108a-b from rotating in both directions.

Any of the features, components, and/or parts, including the arrangements and configurations thereof shown in FIG. 2 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 2.

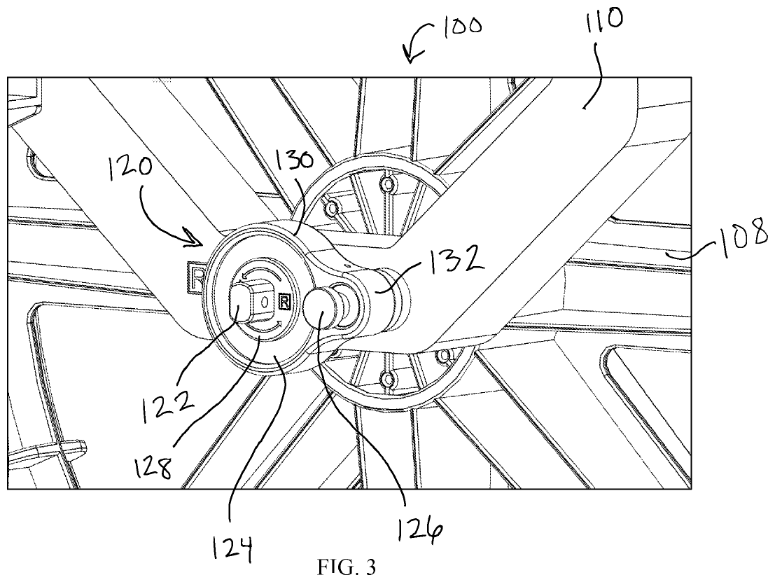

FIG. 3 illustrates a perspective view of a portion of a handcart 100 including a wheel 108 rotatably secured to a strut 110 via an axle 122. The handcart 100 also includes an example of an uphill assist mechanism 120, which can be one non-limiting example of a selectively engageable uphill assist mechanism as described above. The example mechanism 120 shown in FIG. 3 includes a one-way ball bearing 124 including an inner ring 128 engaging and fixed in position relative to the axle 122. The inner ring 128 can rotate relative to the outer ring 130 of the ball bearing 124. The outer ring 130 can include an extension or bulge feature 132 defining a through-hole through which a pin 126 disposed. In this way, the pin 126 can extend through the outer ring 130 to engage the strut 110.

In at least one example, the pin 126 can be operable between two positions, a first position engaging the strut 110 to prevent the rotation of the outer ring 130 relative to the strut 110 and a second position disengaged from the strut 110 to allow a rotation of the outer ring 130 relative to the strut 110.

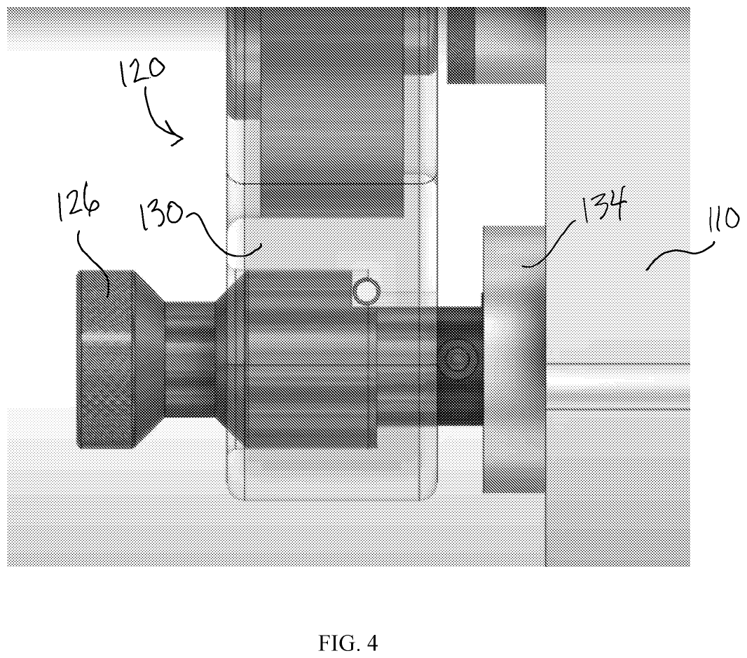

FIG. 4 shows a top view of the mechanism 120 with the outer ring 130 illustrated as transparent to visualize the pin 126 passing there through. The pin 126 is in a first operable position and engaged with the strut 110 to prevent a rotation of the outer ring 130 relative to the strut 110. In at least one example, the strut 110 can include an engagement feature 134 configured to interact with the pin 126 and lock the pin 126 and strut 110 together. In at least one example, the engagement feature 134 can define an aperture or cavity into which at least a portion of the pin 126 can be received in order to mechanically lock the pin 126, and therefore the outer ring 130, together with the strut 110. The pin 126 can be pulled axially to draw the pin 126 away from the strut 110 and disengage the pin 126 from the strut 110.

FIG. 5 shows a view of the pin 126 partially pulled away from the engagement feature 134 of the strut 110. In at least one example, the pin 126 can include one or more spring-loaded balls 136 or other engagement features to promote mechanical engagement with the strut 110 and or with the outer ring 130 when the pin 126 is fully retracted/disengaged from the strut 110. The outer ring 130 and/or the engagement feature 134 of the strut 110 can include complimentary detents or other recesses configured to interact with the spring-loaded balls 136 of the pin 126.

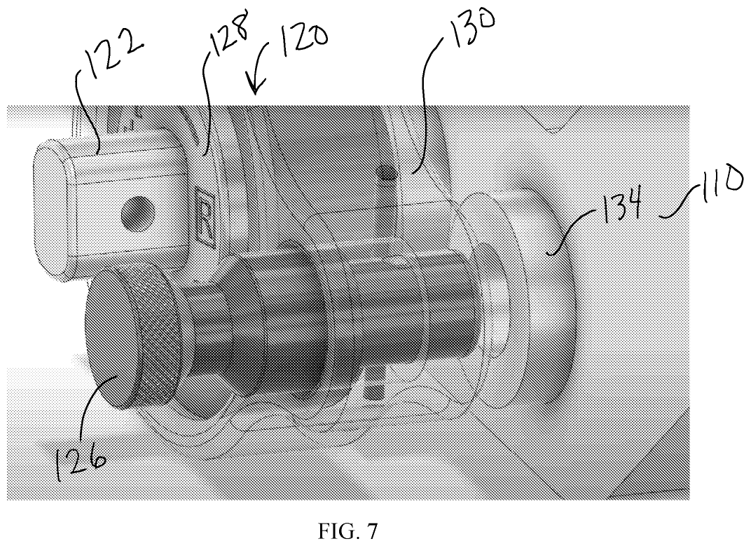

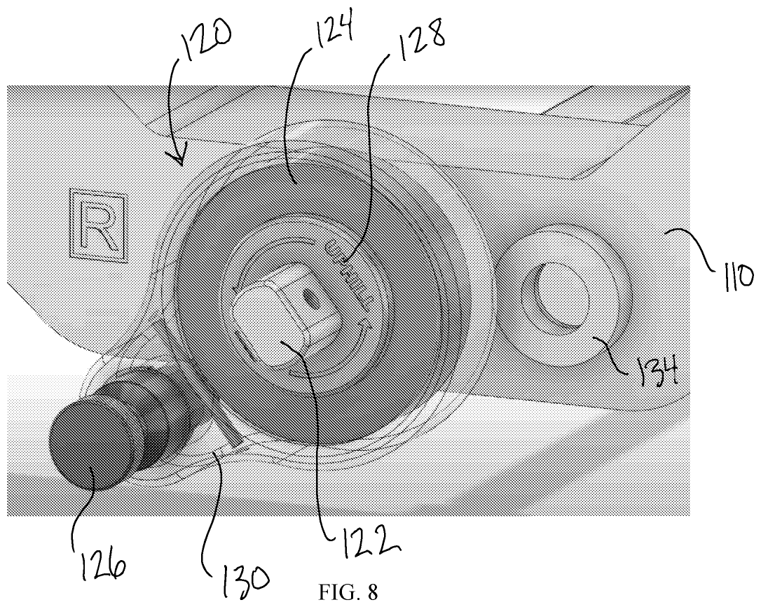

FIGS. 6 and 7 illustrate the pin 126 pulled fully away from the engagement feature 134 of the strut 110 such that the outer ring 130, through which the pin 1126 extends, is free to move relative to the strut 110. FIG. 8 illustrates the assist mechanism 120, including the one-way ball bearing 124, with the outer ring 130 disengaged from the engagement feature 134 of the strut 110 and after some degree of rotation of the outer ring 130 relative to the strut 110. The inner ring 128 of the one-way bearing 124 can only rotate in a single direction relative to the outer ring 130. This is the case whether or not the pin 126 is engaged with the strut 110 to limit the rotation of the outer ring 130 relative to the strut 110 or not.

In this disengaged configuration, the axle 122, which is fixed relative to the inner ring 128 (and the wheel 108 of the handcart 100), can rotate in a first direction and a second direction relative to the strut 110. In the first direction, the inner ring 128 can rotate in the first direction 130 relative to the outer ring 130 and the strut 110 whether or not the pin 126 engages the engagement feature 134 or note. The inner ring 128 cannot rotate in the second direction (opposite the first direction) relative to the outer ring 130 of the one-way bearing 124. But, when the pin 126 is disengaged as shown in FIG. 8, the entire bearing 124, including the outer ring 130, is free to rotate in the second direction relative to the strut 110. Thus, in the disengaged position of the pin 126 shown in FIGS. 6-8, the wheel 108 of the handcart 100 is free to rotate forward and backward.

When the user wants to prevent the wheels 108 of the handcart 100 from rotating backward, for example when parked or moving on an incline, the user can align the pin 126 extending through the outer ring 130 with the engagement feature 134 of the strut 110 such that the axle 122 can only rotate with the wheel 108 in a forward direction. In this way, the user can selectively engage and disengage the uphill assist mechanism 120 as needed.

As noted above, the uphill assist mechanism 120 can include other mechanisms allowing for selectively engaging a one-way limit on the rotation of the axles 122 connecting the wheels 108a-b to the struts 110a-b of the handcart. Other mechanisms can include one-way bearings, which are quiet and limit or eliminate slack between the inner and outer rings, or can include other one-way rotational mechanisms with user operable engagement features.

Any of the features, components, and/or parts, including the arrangements and configurations thereof shown in FIGS. 3-8 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 3-8.

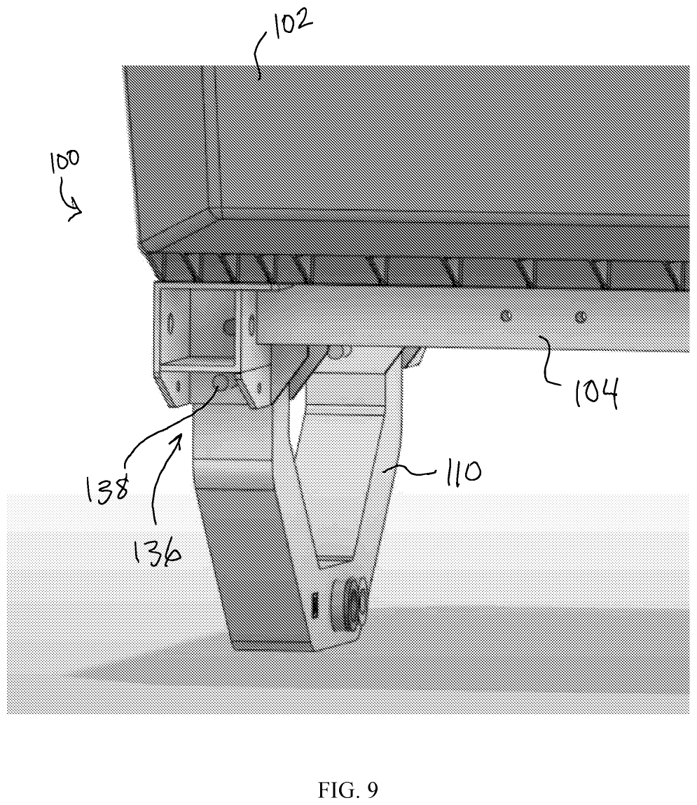

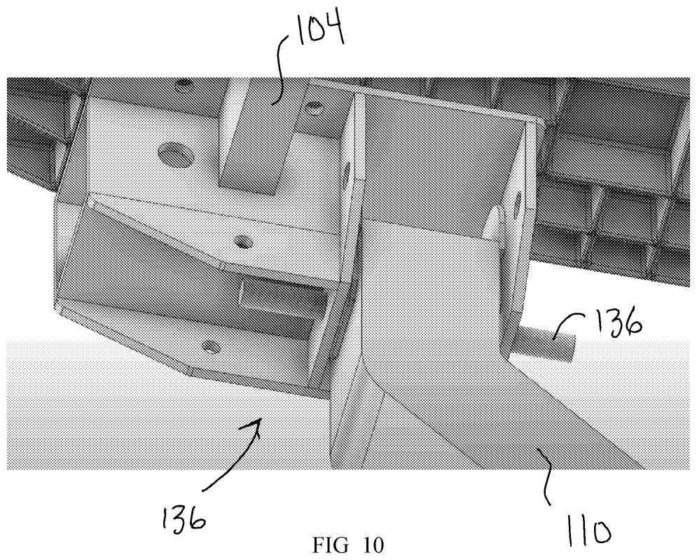

FIG. 9 illustrates an example of a strut 110 of a handcart 100 extending downward from a lower frame 104. The handcart 100 can include a container 102 secured to the top of the lower frame 104. FIG. 9 illustrates a strut 110 without a wheel 108 attached. The wheels 108a-b of the handcart 100 can be selectively secured to the struts 110 such that the user can remove the wheels 108a-b for compact storage and transport of the handcart 100. In at least one example, the strut 110 can attach to the lower frame 104 at a joint 136 with a pin 138 securing the strut 110 as shown. FIG. 10 shows another perspective view of the strut 110 joined with the lower frame 104 at the joint 136 with the pin 138 locking the strut 110 in position relative to the lower frame 104 and joint 136 as shown.

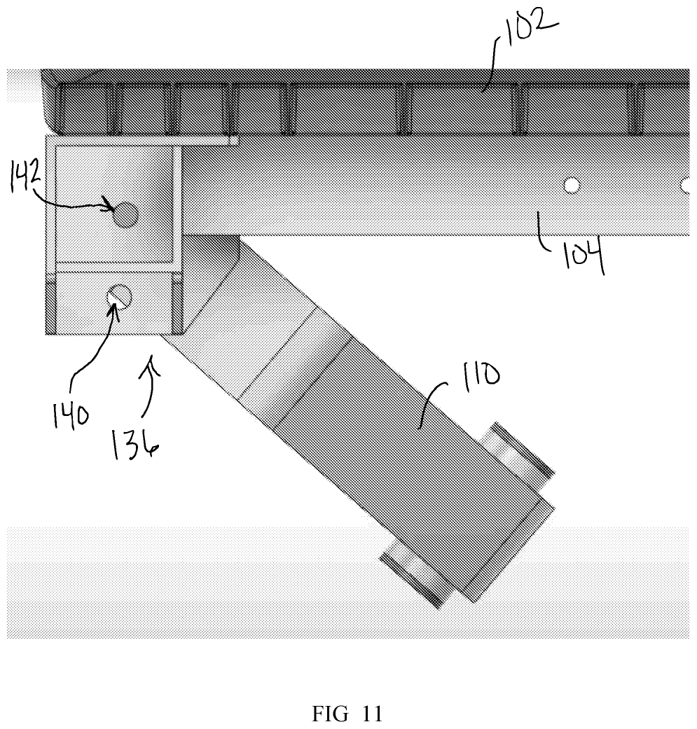

In at least one example, the strut 110 can be selectively pivoted about the joint 136 to fold upward against or adjacent a lower surface of the container 102. FIG. 11 shows the strut 110 partially folded upward with the pin 138 removed from a first pinhole 140 defined by the joint 136. When fixed in position as shown in FIG. 10, the pin 138 can extend through the first pinhole 140 and through a through-hole of the strut 110 aligned with the first pinhole 140 of the joint 136. The joint 136 can also define a second pinhole 142.

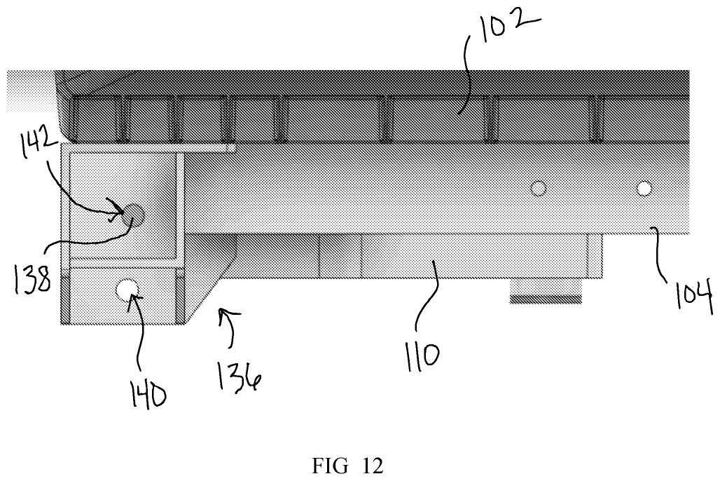

As shown in FIG. 12, when the strut 110 is folded upward into a stowed position against or adjacent a lower surface of the container 102, the pin 136 can pass through the through-hole of the strut 110 as well as the second pinhole 142 of the joint 136 to lock the strut 110 in the stowed position.

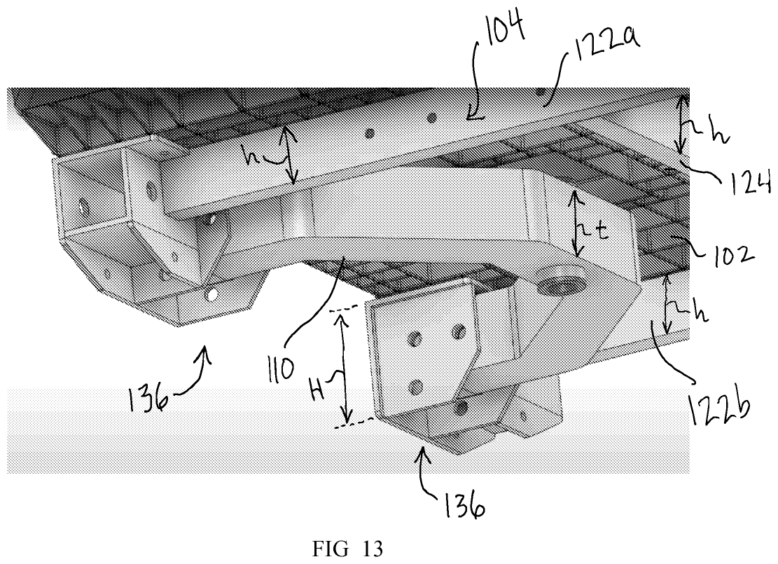

FIG. 13 shows an example of a strut 110 in a stowed position rotated or folded upward against or adjacent a bottom surface of the container 102. The lower frame 104 includes first and second elongate members 122a-b and a cross member 124, each having a height h extending downward from the container 102. In at least one example, the strut 110 includes or defines a thickness t configured to reside within a space or volume defined by the container 102 and the height h of the frame 104 such that the strut 110 substantially sits within the volume when in the stowed position shown in FIG. 13. In at least one example, joints 136 where the strut 110 is pivotally attached to the frame 104 include a height H extending downward from the container 102. In at least one example, the thickness t of the strut 110 is equal to or less than the height H of the joint 126. In at least one example, the thickness t of the strut 110 is less than or equal to the height h of the frame 104. In any case, the strut 110 can be folded upward to sit against the lower side or surface of the container 102 to minimize a total volumetric footprint of the handcart 100 when in the stowed position shown.

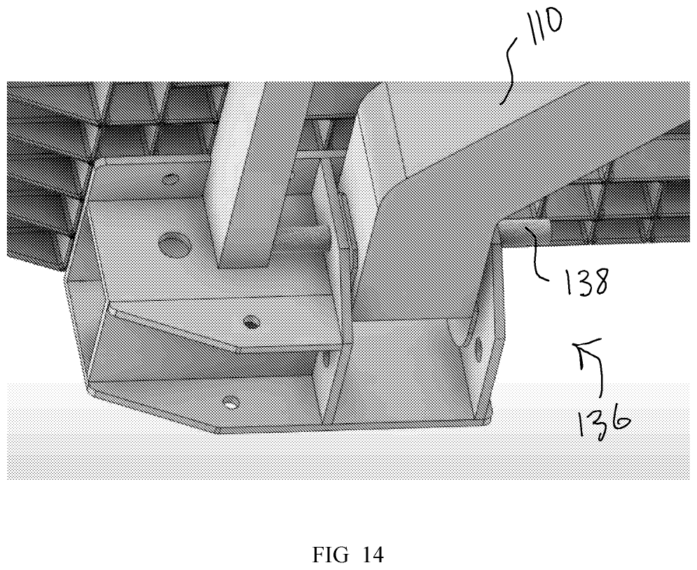

In at least one example, the strut 110 is positioned, configured, and shaped to reside between the first and second elongate members 122a-b and adjacent the cross member 124 as shown. In one example, when both struts 110 are folded upward, the cross member 124 can be disposed between the first and second struts 110 in the stowed position. FIG. 14 shows another perspective view of the strut 110 folded upward in a stowed position with the pin 138 fixing the strut 110 in position.

Any of the features, components, and/or parts, including the arrangements and configurations thereof shown in FIGS. 9-14 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 9-14.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A cart, comprising:
a wheel axle; and
an uphill assist mechanism engaging the wheel axle, wherein the uphill assist mechanism is selectively engageable by a user to:
allow a rotation of the axle in a first direction and a second direction opposite the first direction; and
limit the rotation in the second direction and allow the rotation in the first direction.

2. A cart, comprising:
a container;
a wheel; and
an adjustable wheel strut configured to rotatably secure the wheel to the container;
wherein the adjustable wheel strut is configured to be rotated to extend downward from the container when secured to the wheel or upward against a lower surface of the container in a stowed position.
